(19) United States
(12) Patent Application Publication
(10) Pub. No.: US 2024/0275438 A1
(43) Pub. Date: Aug. 15, 2024

(54) METHOD AND APPARATUS FOR CODEBOOK-BASED CSI REPORTING FOR FULL CHANNEL MATRICES

(71) Applicant: Samsung Electronics Co., Ltd., Suwon-si (KR)

(72) Inventors: Ameha Tsegaye ABEBE, Suwon-si (KR); Kyoungmin PARK, Suwon-si (KR); Seongmok LIM, Suwon-si (KR); Youngrok JANG, Suwon-si (KR); Hyoungju JI, Suwon-si (KR); Kyungjun CHOI, Suwon-si (KR)

(21) Appl. No.: 18/436,450

(22) Filed: Feb. 8, 2024

(30) Foreign Application Priority Data
Feb. 10, 2023 (KR) 10-2023-0018120

(51) Int. Cl. H04B 7/0456; H04B 7/06

(52) U.S. Cl. CPC H04B 7/0456; H04B 7/0626

(57) ABSTRACT

The disclosure relates to a 5G or 6G communication system for supporting a higher data transmission rate. A method performed by a user equipment (UE) in a wireless communication system, the method comprising: receiving, from a base station, configuration information for a channel state information (CSI) report; identifying a precoding matrix indicator (PMI) of at least one code book based on the configuration information; and transmitting, to the base station, the CSI report including the PMI, wherein the PMI indicates information related to UE-side vectors and base station-side vectors.

### CROSS-REFERENCE TO RELATED APPLICATION(S)

This application is based on and claims priority under 35 U.S.C. § 119(a) of a Korean patent application number 10-2023-0018120, filed on Feb. 10, 2023, in the Korean Intellectual Property Office, the disclosure of which is incorporated by reference herein in its entirety.

### BACKGROUND

### 1. Field

The disclosure relates to the field of 5th generation (5G) and beyond 5G communication networks. More particularly, the disclosure relates to channel state information (CSI) feedback in multiple-input multiple-output (MIMO) system.

### 2. Description of Related Art

5G mobile communication technologies define broad frequency bands such that high transmission rates and new services are possible, and can be implemented not only in “Sub 6 GHz” bands, such as 3.5 GHZ, but also in “Above 6 GHz” bands referred to as millimeter wave (mmWave) including 28 GHz and 39 GHz. In addition, it has been considered to implement 6th generation (6G) mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods, such as a low density parity check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies, such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies, such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step random-access channel (RACH) for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR), and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies, such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and artificial intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below.

Accordingly, an aspect of the disclosure is to disclose provide a method performed by a user equipment (UE) in a wireless communication system, the method comprising: receiving, from a base station, configuration information for a channel state information (CSI) report; identifying a precoding matrix indicator (PMI) of at least one code book based on the configuration information; and transmitting, to the base station, the CSI report including the PMI, wherein the PMI indicates information related to UE-side vectors and base station-side vectors.

Accordingly, an aspect of the disclosure is to disclose provide a method performed by a base station in a wireless communication system, the method comprising: transmitting, to a user equipment (UE), configuration information for a channel state information (CSI) report; and receiving, from the UE, the CSI report including a precoding matrix indicator (PMI), wherein the PMI of at least one code book is identified based on the configuration information, and wherein the PMI indicates information related to UE-side vectors and base station-side vectors.

Accordingly, an aspect of the disclosure is to disclose provide a user equipment (UE) in a wireless communication system, the UE comprising a transceiver; and at least one processor couple to the transceiver and configured to: receive, from a base station, configuration information for a channel state information (CSI) report, identify a precoding matrix indicator (PMI) of at least one code book based on the configuration information, and transmit, to the base station, the CSI report including the PMI, wherein the PMI indicates information related to UE-side vectors and base station-side vectors.

Accordingly, an aspect of the disclosure is to disclose provide a base station in a wireless communication system, the base station comprising a transceiver; and at least one processor couple to the transceiver and configured to: transmit, to a user equipment (UE), configuration information for a channel state information (CSI) report, and receive, from the UE, the CSI report including a precoding matrix indicator (PMI), wherein the PMI of at least one code book is identified based on the configuration information, and wherein the PMI indicates information related to UE-side vectors and base station-side vectors.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a wireless network according to an embodiment of the disclosure;

FIGS. 2A and 2B illustrate wireless transmit and receive paths according to various embodiments of the disclosure;

FIGS. 3A and 3B illustrate a user equipment (UE) and a gNodeB (gNB) according to various embodiments of the disclosure;

FIG. 4 illustrates a cross-polarized multiple-input multiple-output (MIMO) antenna system according to an embodiment of the disclosure;

FIG. 5 illustrates a layout for channel state information reference signal (CSI-RS) resource mapping in an orthogonal frequency division multiple access (OFDM) time-frequency grid according to an embodiment of the disclosure;

FIG. 6 illustrates a precoder construction in Type II CSI according to an embodiment of the disclosure;

FIG. 7A illustrates a reporting precoding matrices in subband granularity according to an embodiment of the disclosure;

FIG. 7B illustrates a precoding matrix construction for enhanced Type II CSI according to an embodiment of the disclosure;

FIG. 8 illustrates an autoencoder based CSI feedback according to an embodiment of the disclosure;

FIG. 9 depicts an embodiment for an autoencoder based CSI feedback wherein a preprocessing unit transforms an estimated channel to stacked eigenvectors according to an embodiment of the disclosure;

FIGS. 10A and 10B illustrate interference nulling operation for multi-user (MU)-MIMO by an gNB upon reception of CSI report with precoding matrices and full channel matrices, respectively according to various embodiments of the disclosure;

FIGS. 11A and 1B illustrate use cases for CSI report corresponding to multiple time instances periods according to an embodiment of the disclosure;

FIGS. 12A, 12B, and 12C illustrate a CSI report configuration approach according to an embodiment of the disclosure;

FIGS. 13A and 13B illustrate an embodiment for two parts CSI reporting for CSI reporting corresponding to full channel matrices reporting according to an embodiment of the disclosure;

FIG. 14 illustrates a configuration for time-frequency granularity of UE-side and gNB side channel components reporting according to an embodiment of the disclosure;

FIG. 15 illustrates an example of an operation of a UE according to an embodiment of the disclosure; and

FIG. 16 illustrates an example of an operation of a base station according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The below flowcharts illustrate example methods that can be implemented in accordance with the principles of the disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4^{th} generation (4G) communication systems, and to enable various vertical applications, 5^{th} generation (5G) communication systems have been developed and are currently being deployed.

The 5G communication system is considered to be implemented to include higher frequency (mmWave) bands, such as 28 GHz or 60 GHz bands or, in general, above 6 GHz bands, so as to accomplish higher data rates, or in lower frequency bands, such as below 6 GHz, to enable robust coverage and mobility support. Aspects of the disclosure may be applied to deployment of 5G communication systems, 6G or even later releases which may use THz bands. To decrease propagation loss of the radio waves and increase the transmission distance, the beamforming, massive multiple-input multiple-output (MIMO), full dimensional MIMO (FD-MIMO), array antenna, an analog beam forming, large-scale antenna techniques are discussed in 5G communication systems.

In addition, in 5G communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancellation and the like.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

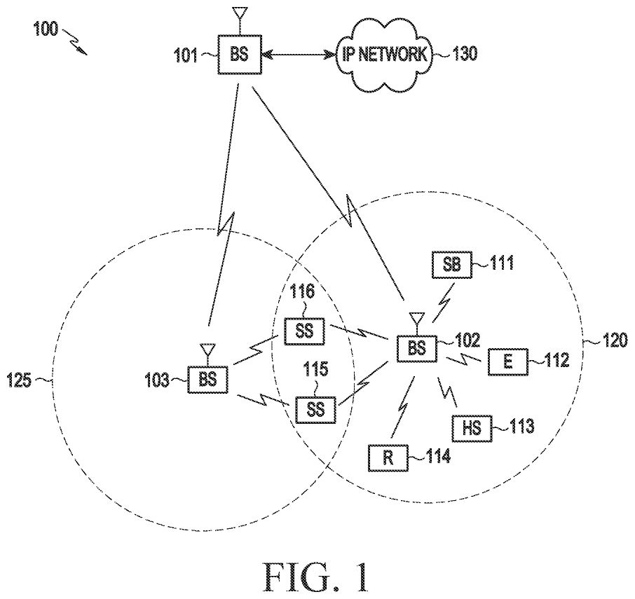

FIG. 1 illustrates a wireless network according to an embodiment of the disclosure.

Referring to FIG. 1, a wireless network 100 is for illustration only. Other embodiments of the wireless network 100 can be used without departing from the scope of this disclosure.

The wireless network 100 includes an gNodeB (gNB) 101, an gNB 102, and an gNB 103. The gNB 101 communicates with the gNB 102 and the gNB 103. The gNB 101 also communicates with at least one Internet protocol (IP) network 130, such as the Internet, a proprietary IP network, or other data network.

Depending on the network type, the term ‘gNB’ can refer to any component (or collection of components) configured to provide remote terminals with wireless access to a network, such as base transceiver station, a radio base station, transmit point (TP), transmit-receive point (TRP), a ground gateway, an airborne gNB, a satellite system, mobile base station, a macrocell, a femtocell, a Wi-Fi access point (AP) and the like. In addition, depending on the network type, other well-known terms may be used instead of “user equipment” or “UE,” such as “mobile station,” “subscriber station,” “remote terminal,” “wireless terminal,” or “user device.” For the sake of convenience, the terms “user equipment” and “UE” are used in this patent document to refer to equipment that wirelessly accesses a gNB. The UE could be a mobile device or a stationary device. For example, UE could be a mobile telephone, smartphone, monitoring device, alarm device, fleet management device, asset tracking device, automobile, desktop computer, entertainment device, infotainment device, vending machine, electricity meter, water meter, gas meter, security device, sensor device, appliance, or the like.

The gNB 102 provides wireless broadband access to the IP network 130 for a first plurality of user equipment (UEs) within a coverage area 120 of the gNB 102. The first plurality of UEs includes a UE 111, which may be located in a small business (SB), a UE 112, which may be located in an enterprise (E), a UE 113, which may be located in a Wi-Fi hotspot (HS), a UE 114, which may be located in a first residence (R), a UE 115, which may be located in a second residence (R), and a UE 116, which may be a mobile device (M) like a cell phone, a wireless laptop, a wireless PDA, or the like. The gNB 103 provides wireless broadband access to the IP network 130 for a second plurality of UEs within a coverage area 125 of the gNB 103. The second plurality of UEs includes the UE 115 and the UE 116. In some embodiments of the disclosure, one or more of the gNBs 101-103 may communicate with each other and with the UEs 111-116 using 5G, long-term evolution (LTE), LTE-advanced (LTE-A), WiMAX, or other advanced wireless communication techniques.

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described below, one or more of BS 101, BS 102 and BS 103 include two-dimensional (2D) antenna arrays as described in embodiments of the disclosure. In some embodiments of the disclosure, one or more of BS 101, BS 102 and BS 103 support the codebook design and structure for systems having 2D antenna arrays.

Although FIG. 1 illustrates one example of a wireless network 100, various changes may be made to FIG. 1. For example, the wireless network 100 can include any number of gNBs and any number of UEs in any suitable arrangement. In addition, the gNB 101 can communicate directly with any number of UEs and provide those UEs with wireless broadband access to the IP network 130. Similarly, each gNB 102-103 can communicate directly with the IP network 130 and provide UEs with direct wireless broadband access to the IP network 130. Further, the gNB 101, 102, and/or 103 can provide access to other or additional external networks, such as external telephone networks or other types of data networks.

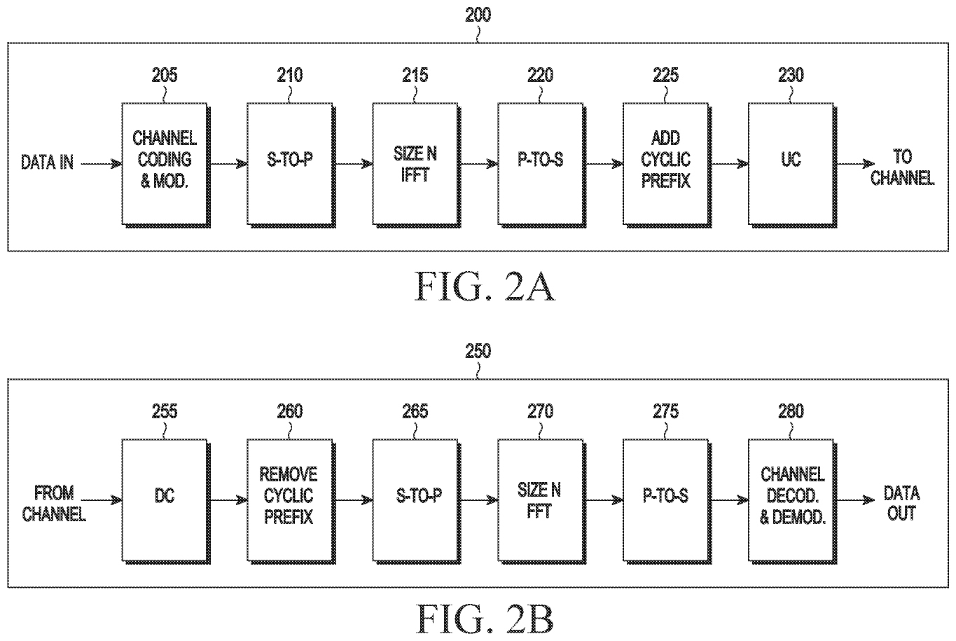

FIGS. 2A and 2B illustrate a wireless transmit and receive paths according to various embodiments of the disclosure.

Referring to FIGS. 2A and 2B, a transmit path 200 may be described as being implemented in an gNB (such as gNB 102), while a receive path 250 may be described as being implemented in a UE (such as the UE 116). However, it will be understood that the receive path 250 can be implemented in an gNB and that the transmit path 200 can be implemented in a UE. In some embodiments of the disclosure, the receive path 250 is configured to support the codebook design and structure for systems having 2D antenna arrays as described in embodiments of the disclosure.

The transmit path 200 includes a channel coding and modulation block 205, a serial-to-parallel (S-to-P) block 210, a size N inverse fast Fourier transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N fast Fourier transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as discrete Fourier transform (DFT) and inverse discrete Fourier transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. In addition, FIGS. 2A and 2B are meant to illustrate examples of the types of transmit and receive paths that can be used in a wireless network. Any other suitable architectures can be used to support wireless communications in a wireless network.

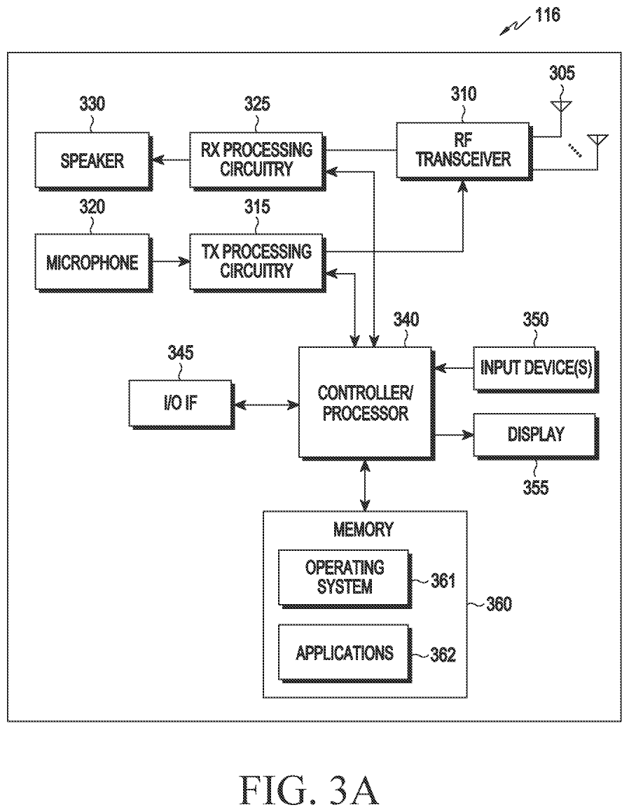

FIG. 3A illustrates a UE according to an embodiment of the disclosure.

Referring to FIG. 3A, the UE 116 illustrated in FIG. 3A is for illustration only, and the UEs 111-115 of FIG. 1 can have the same or similar configuration. However, UEs come in a wide variety of configurations, and FIG. 3A does not limit the scope of this disclosure to any particular implementation of a UE.

The UE 116 includes an antenna 305, a radio frequency (RF) transceiver 310, transmit (TX) processing circuitry 315, a microphone 320, and receive (RX) processing circuitry 325. The UE 116 also includes a speaker 330, a main processor 340, an input/output (I/O) interface (IF) 345, a keypad 350, a display 355, and memory 360. The memory 360 includes a basic operating system (OS) program 361 and one or more applications 362.

The RF transceiver 310 receives, from the antenna 305, an incoming RF signal transmitted by an gNB of the network 100. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the main processor 340 for further processing (such as for web browsing data).

The TX processing circuitry 315 receives analog or digital voice data from the microphone 320 or other outgoing baseband data (such as web data, e-mail, or interactive video game data) from the main processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The main processor 340 can include one or more processors or other processing devices and execute the basic OS program 361 stored in the memory 360 in order to control the overall operation of the UE 116. For example, the main processor 340 can control the reception of forward channel signals and the transmission of reverse channel signals by the RF transceiver 310, the RX processing circuitry 325, and the TX processing circuitry 315 in accordance with well-known principles. In some embodiments of the disclosure, the main processor 340 includes at least one microprocessor or microcontroller.

The main processor 340 is also capable of executing other processes and programs resident in the memory 360, such as operations for channel quality measurement and reporting for systems having 2D antenna arrays as described in embodiments of the disclosure as described in embodiments of the disclosure. The main processor 340 can move data into or out of the memory 360 as required by an executing process. In some embodiments of the disclosure, the main processor 340 is configured to execute the applications 362 based on the OS program 361 or in response to signals received from gNBs or an operator. The main processor 340 is also coupled to the I/O interface 345, which provides the UE 116 with the ability to connect to other devices, such as laptop computers and handheld computers. The I/O interface 345 is the communication path between these accessories and the main controller 340.

The main processor 340 is also coupled to the keypad 350 and the display 355. The operator of the UE 116 can use the keypad 350 to enter data into the UE 116. The display 355 may be a liquid crystal display or other display capable of rendering text and/or at least limited graphics, such as from web sites. The memory 360 is coupled to the main processor 340. Part of the memory 360 can include random access memory (RAM), and another part of the memory 360 can include flash memory or other read-only memory (ROM).

Although FIG. 3A illustrates one example of the UE 116, various changes may be made to FIG. 3A. For example, various components in FIG. 3A can be combined, further subdivided, or omitted and additional components can be added according to particular needs. As a particular example, the main processor 340 can be divided into multiple processors, such as one or more central processing units (CPUs) and one or more graphics processing units (GPUs). In addition, while FIG. 3A illustrates the UE 116 configured as a mobile telephone or smartphone, UEs can be configured to operate as other types of mobile or stationary devices.

FIG. 3B illustrates a gNB according to an embodiment of the disclosure.

Referring to FIG. 3A, the gNB 102 is for illustration only, and other gNBs of FIG. 1 can have the same or similar configuration. However, gNBs come in a wide variety of configurations, and FIG. 3B does not limit the scope of this disclosure to any particular implementation of an gNB. It is noted that gNB 101 and gNB 103 can include the same or similar structure as gNB 102.

Referring to FIG. 3B, the gNB 102 includes multiple antennas 370a-370n, multiple RF transceivers 372a-372n, transmit (TX) processing circuitry 374, and receive (RX) processing circuitry 376. In certain embodiments of the disclosure, one or more of the multiple antennas 370a-370n include 2D antenna arrays. The gNB 102 also includes a controller/processor 378, memory 380, and a backhaul or network interface 382.

The RF transceivers 372a-372n receive, from the antennas 370a-370n, incoming RF signals, such as signals transmitted by UEs or other gNBs. The RF transceivers 372a-372n down-convert the incoming RF signals to generate IF or baseband signals. The IF or baseband signals are sent to the RX processing circuitry 376, which generates processed baseband signals by filtering, decoding, and/or digitizing the baseband or IF signals. The RX processing circuitry 376 transmits the processed baseband signals to the controller/processor 378 for further processing.

The TX processing circuitry 374 receives analog or digital data (such as voice data, web data, e-mail, or interactive video game data) from the controller/processor 378. The TX processing circuitry 374 encodes, multiplexes, and/or digitizes the outgoing baseband data to generate processed baseband or IF signals. The RF transceivers 372a-372n receive the outgoing processed baseband or IF signals from the TX processing circuitry 374 and up-converts the baseband or IF signals to RF signals that are transmitted via the antennas 370a-370n.

The controller/processor 378 can include one or more processors or other processing devices that control the overall operation of the gNB 102. For example, the controller/processor 378 can control the reception of forward channel signals and the transmission of reverse channel signals by the RF transceivers 372a-372n, the RX processing circuitry 376, and the TX processing circuitry 374 in accordance with well-known principles. The controller/processor 378 can support additional functions as well, such as more advanced wireless communication functions. For instance, the controller/processor 378 can perform the blind interference sensing (BIS) process, such as performed by a BIS algorithm, and decodes the received signal subtracted by the interfering signals. Any of a wide variety of other functions can be supported in the gNB 102 by the controller/processor 378. In some embodiments of the disclosure, the controller/processor 378 includes at least one microprocessor or microcontroller.

The controller/processor 378 is also capable of executing programs and other processes resident in the memory 380, such as a basic OS. The controller/processor 378 is also capable of supporting channel quality measurement and reporting for systems having 2D antenna arrays as described in embodiments of the disclosure. In some embodiments of the disclosure, the controller/processor 378 supports communications between entities, such as web real-time communication (RTC). The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The network interface 382 can support communications over any suitable wired or wireless connection(s). For example, when the gNB 102 is implemented as part of a cellular communication system (such as one supporting 5G, LTE, or LTE-A), the network interface 382 can allow the gNB 102 to communicate with other gNBs over a wired or wireless backhaul connection. When the gNB 102 is implemented as an access point, the network interface 382 can allow the gNB 102 to communicate over a wired or wireless local area network or over a wired or wireless connection to a larger network (such as the Internet). The network interface 382 includes any suitable structure supporting communications over a wired or wireless connection, such as an Ethernet or RF transceiver.

The memory 380 is coupled to the controller/processor 378. Part of the memory 380 can include a RAM, and another part of the memory 380 can include flash memory or other ROM. In certain embodiments of the disclosure, a plurality of instructions, such as a BIS algorithm is stored in memory. The plurality of instructions are configured to cause the controller/processor 378 to perform the BIS process and to decode a received signal after subtracting out at least one interfering signal determined by the BIS algorithm.

As described below, the transmit and receive paths of the gNB 102 (implemented using the RF transceivers 372a-372n, TX processing circuitry 374, and/or RX processing circuitry 376) support communication with aggregation of FDD cells and TDD cells.

Although FIG. 3B illustrates one example of a gNB 102, various changes may be made to FIG. 3B. For example, the gNB 102 can include any number of each component shown in FIG. 3B. As a particular example, an access point can include a number of interfaces 382, and the controller/processor 378 can support routing functions to route data between different network addresses. As another particular example, while shown as including a single instance of TX processing circuitry 374 and a single instance of RX processing circuitry 376, the gNB 102 can include multiple instances of each (such as one per RF transceiver).

Multiple input multiple output (MIMO) system wherein a BS and/or a UE is equipped with multiple antennas has been widely employed in wireless systems for its advantages in terms of spatial multiplexing, diversity gain and array gain.

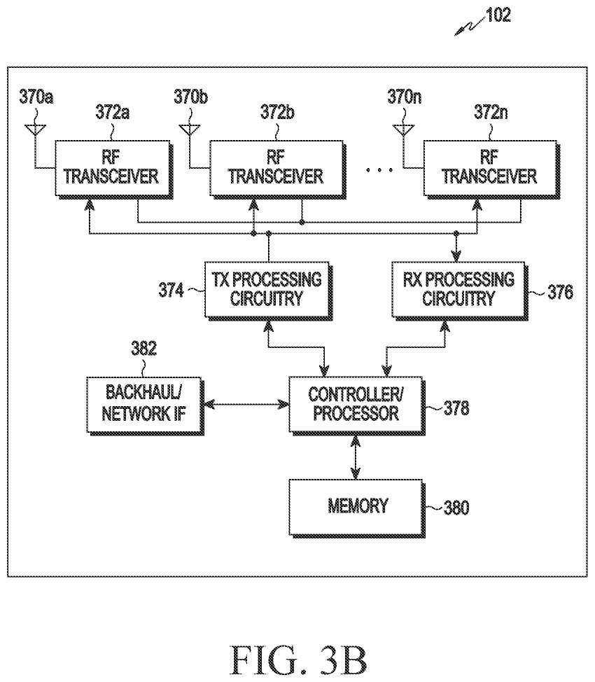

FIG. 4 illustrates a MIMO antenna configuration with antenna elements according to an embodiment of the disclosure.

Referring to FIG. 4, 4 cross-polarized 401 antenna elements form a 4×1 subarray 402. 12 subarrays form a 2V3H MIMO antennas configuration consisting 2 and 3 subarrays in vertical 404 and horizontal dimensions 403, respectively. Although FIG. 4 illustrates one example of MIMO antenna configuration, the disclosure can be applied to various such configurations.

In MIMO systems, the channel state information (CSI) is required at the base station (BS) so that a signal from the BS is received at the UE with maximum possible received power and minimum possible interference. The acquisition of CSI at the BS can be via a measurement at the BS from an UL reference signal or via a measurement and feedback by the UE from a DL reference signal for time-domain duplexing (TDD) and frequency-domain duplexing (FDD) systems, respectively. In 5G FDD systems, the channel state information reference signal (CSI-RS) is the primary reference signal that is used by the UE to measure and report CSI.

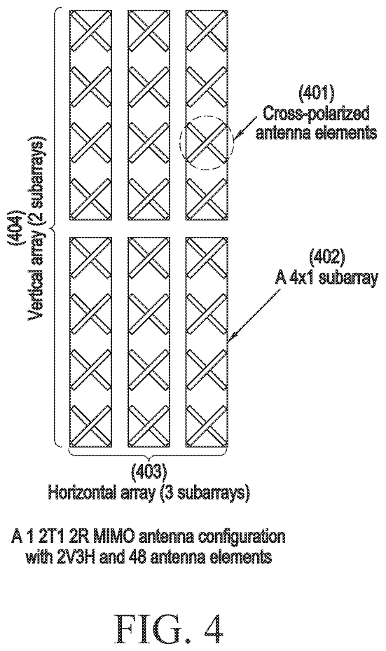

FIG. 5 illustrates a layout for channel state information reference signal (CSI-RS) resource mapping in an orthogonal frequency division multiple access (OFDM) time-frequency grid according to an embodiment of the disclosure.

In some embodiments of the disclosure, a UE may receive a configuration signaling from a BS for a CSI-RS that can be used for channel measurement. An example of such configuration is illustrated in FIG. 5.

Referring to FIG. 5, 12 antenna ports (CSI-RS ports) are mapped to a CSI-RS with 3 code-domain multiplexing (CDM) groups, wherein each CDM group is mapped to 4 resource elements (REs) in OFDM time-frequency grid. The antenna ports that are mapped to the same CDM group can be orthogonalized in code-domain by employing orthogonal cover codes. The CSI-RS configuration in FIG. 5 can be related to the MIMO antenna configuration in FIG. 4, by mapping a CSI-RS port to one of the polarization of a subarray. In the 5G NR standards, three time-domain CSI-RS resources configurations, namely periodic, semi-persistent and aperiodic are possible. In the figure, an illustrative example of periodic configuration is given with a period of 4 slots.

In some embodiments of the disclosure, the BS is capable of configuring a UE, by a higher layer signaling, with information for a CSI feedback that may include spatial channel information indicator and other supplementary information that would help the BS to have an accurate CSI. The spatial channel indicator, which is reported via a precoding matrix indicator (PMI) in 4G and 5G specifications, comprises a single or a plurality of channel matrix, the channel covariance matrix, the eigenvectors, or spatial sampling basis vectors. More particularly, in 4G and 5G specification, the spatial channel information can be given by a single or a plurality of discrete Fourier transform (DFT) basis vectors.

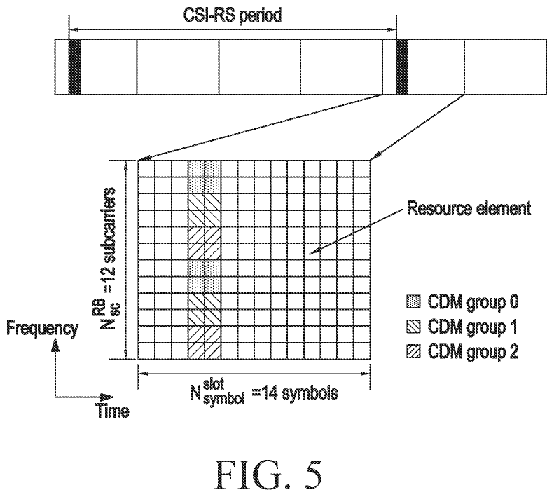

FIG. 6 illustrates a precoder construction in Type II CSI according to an embodiment of the disclosure.

Referring to FIG. 6, it illustrates an example of CSI feedback based on a plurality of DFT basis vectors for what is known as Type II CSI in 5G NR. The spatial information of the channel is reported in terms of L=4 DFT basis vectors {b₀,b₁,b₂,b₃} 602 from a set of candidate DFT basis vectors 601. Additionally, amplitude information {p₀, p₁, p₂, p₃} 603 and co-phasing information {φ₀,φ₁,φ₂,φ₃} (604) are reported. Thus, in Type II CSI a dual-stage precoding matrix is given as W=W₁W₂, where, W₁ select the DFT basis vectors and W₂ assign amplitude and co-phasing coefficients. Furthermore, a codebook can be defined as superset of candidate DFT basis vectors as well as candidate amplitude and phase coefficients. Then, a reported PMI would consist of indicators to the elements of a codebook that can represent the estimated channel.

In one embodiment of the disclosure, amplitude and phase information are reported in such a way that the linear combination of the basis vectors, i.e.,

$$b = {\sum }_{i = 0}^{L - 1} {e}^{2 π {φ}_{i}} {p}_{i} {b}_{i} ,$$

is matched to the eigenvector direction of the channel. Specifically, for a channel matrix H with the (s,u)-th element representing the channel gain between the s-th transmit and the u-th receive antenna, the eigenvectors of the covariance matrix H^{H}H can be considered. Let eₗ denote one of the eigenvectors, then the PMI can be selected by the UE in such a way that the value ∥eₗ^{H}b∥ is maximized.

Moreover, a UE can be configured in different ways to report a tuple of DFT basis vectors, amplitude coefficients and the phase coefficients, based on polarization-common or polarization-specific manner. For example, in 5G NR specifications, DFT basis vectors are reported in a polarization-common manner while phase and amplitude coefficients are reported in polarization specific manner, i.e., reported per polarization. MIMO systems allow spatial multiplexing, i.e., transmission of data in multiple transmission layers. In this regard, the type II CSI in the 5G NR allows the DFT basis vectors to be reported in a layer-common manner, i.e., common basis for all layers, while phase and amplitude coefficients to be reported in a layer-specific manner.

In order to account for the frequency-selectivity of a wideband channel, some embodiments allow various components of the precoding matrix, i.e., components of PMI, to be reported per frequency ranges. In some configurations, the frequency band the UE is configured for CSI reporting is partitioned into a set of subbands and the amplitude and/or phases coefficients are reported per a subband manner. In particular, the DL BWP can be partitioned in to subbands with subband size N_{PRB}^{SB} physical resource blocks (PRBs). Then the selected DFT basis vectors are linearly combined with different weights so that the resulting vector is aligned to the eigenvector of the channel in that subband. Denoting the set of subcarriers in the k-th subband as Fₖ, then the eigenvectors of the averaged covariance matrix

$${C}_{k} = \frac{1}{\vert {F}_{k} \vert} = {\sum }_{f ∈ {F}_{k}} ( {( {H}_{f , k} )}^{H} ( {H}_{f , k} ) )$$

can be considered, where, f∈Fₖ are subcarriers in the k-^{th} subband and H_{f,k} is the corresponding channel matrix.

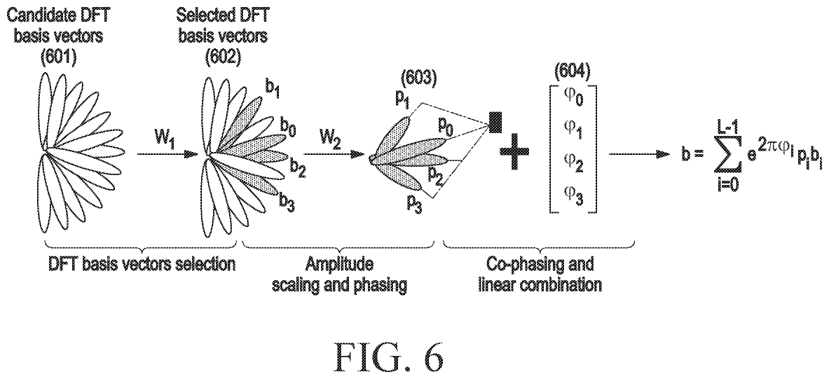

FIG. 7A illustrates a frequency selective linear combination of DFT basis vectors 703 for K subbands of size N_{PRB}^{SB} 702 according to an embodiment of the disclosure.

Referring to FIG. 7A, in 5G NR specifications, another configuration, known as enhanced Type II (eType II) CSI, allows reporting amplitude and phase coefficients in a delay-domain rather than per subband reporting in frequency-domain. This configuration reduces the feedback overhead as the delay components are usually much smaller than the equivalent number of subbands. In enhanced Type II codebook (eType II CB) (FIG. 7B), precoding matrices are reported in delay domain by employing frequency-domain (FD) DFT basis 701 rather than the frequency domain reporting in Type II CSI (FIG. 7A), i.e., per subband or wideband.

FIG. 7B illustrates construction of eType II CSI according to an embodiment of the disclosure.

Referring to FIG. 7B, a precoding matrix is expressed in three-stages W=W₁W₂W_{f}^{H} (706). The spatial domain selection matrix W₁ selects L DFT vectors from P=2N₁N₂ CSI-RS ports, consequently, it has 2L rows accounting for the cross-polarized antennas. Moreover, an Mᵥ×N₃ matrix WH corresponds to Mᵥ DFT basis vectors (705) that can transform the precoding matrix reported in delay domain for delay components to a frequency domain with N₃ frequency domain points (bins) (704). More particularly, the t∈{1, 2, . . . , N₃}₋_{^{th}} element of f-th vector is given by

$${y}_{t , l}^{( f )} = {e}^{j \frac{2 π {tn}_{3 , l}^{( f )}}{{N}_{3}}} .$$

Finally, the matrix W₂ carries the amplitude and phase information wherein the i-^{th} and j-^{th} element, w_{i,j}, carries amplitude (707) and phase (708) information of i-^{th} 2D DFT beam and j-^{th} delay component.

In order to further reduce the CSI overhead, a system may exploit angle-delay reciprocity and measure the dominant angle and delay components of a channel from an UL reference signal, such as sounding reference signal (SRS). Then, a precoded CSI-RS can be considered for DL CSI measurement wherein the CSI-RS ports are mapped to an angle-delay component of the channel. Moreover, delay pre-compensation can be applied to the CSI ports so that the UE would measure CSI for a fewer number of delay components, i.e., in the extreme case for just one delay component.

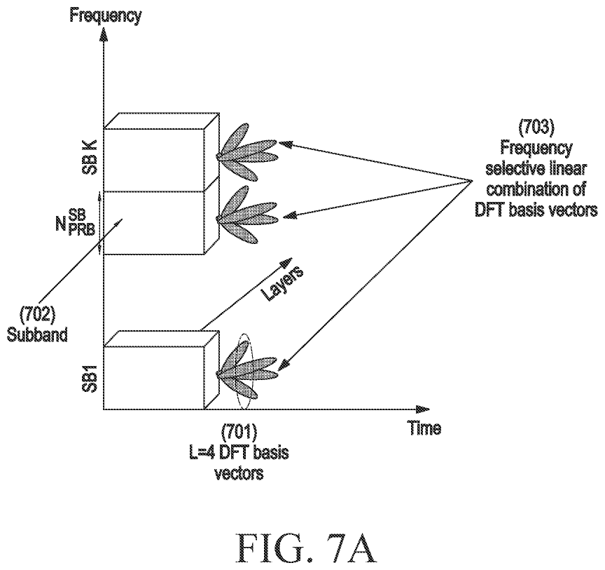

FIG. 8 illustrates an autoencoder based CSI feedback according to an embodiment of the disclosure.

Referring to FIG. 8, artificial intelligence (AI)-based CSI feedback has gained considerable attention. More particularly, an auto-encoder (AE) (800) consisting of an encoder part (801) at a UE (803) generates the CSI feedback and a decoder (802) at a gNB (804) reconstructs the CSI feedback. The main aim of an AE-based CSI feedback is to find the best representation of a channel state information in terms of feedback overhead. In another words, AE compresses the CSI to reduce the CSI feedback overhead.

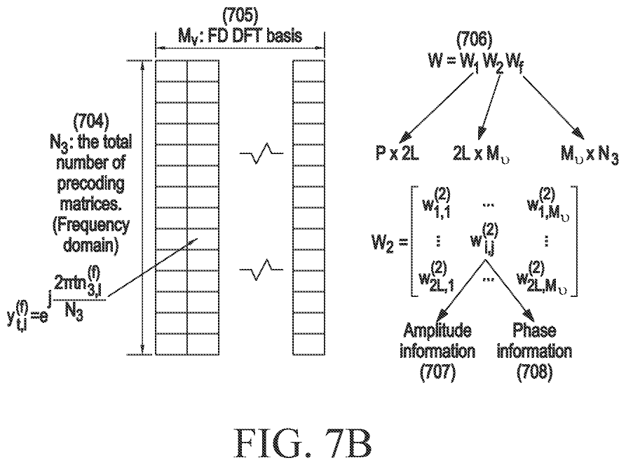

The input for an autoencoder can take different formats. In an embodiment of the disclosure, the input can be the eigenvectors of the channel. The covariance matrix of an Nₜ×Nᵣ channel matrix H given as H^{H}H can be computed by the UE. Then, the dominant eigenvectors of the covariance matrix eig(H^{H}H)=VΣΛ given as V=[v₁ . . . vᵣ] can be considered as an input for the autoencoder. An illustration of such embodiment is given in FIG. 9.

FIG. 9 depicts an embodiment for an autoencoder based CSI feedback wherein a preprocessing unit transforms an estimated channel to stacked eigenvectors according to an embodiment of the disclosure.

Referring to FIG. 9, a set of Nₛ channel matrices which belong to Nₛ subbands, i.e., {Hₛ}ₛ₌₁^{N}^{ₛ}, is input (906) for a pre-processing unit in (903). The preprocessing unit compute the Nₛ eigenvectors and stack them as a column of a matrix V_{stack} (907). An encoder (901) then generates a CSI feedback in terms of a bit stream S (905). The decoder (902) part of the autoencoder (900), takes the CSI feedback and reconstructs the stacked eigenvectors. Moreover, a gNB then may use the reconstructed stacked eigenvectors \hat{V}_{stack} as precoders.

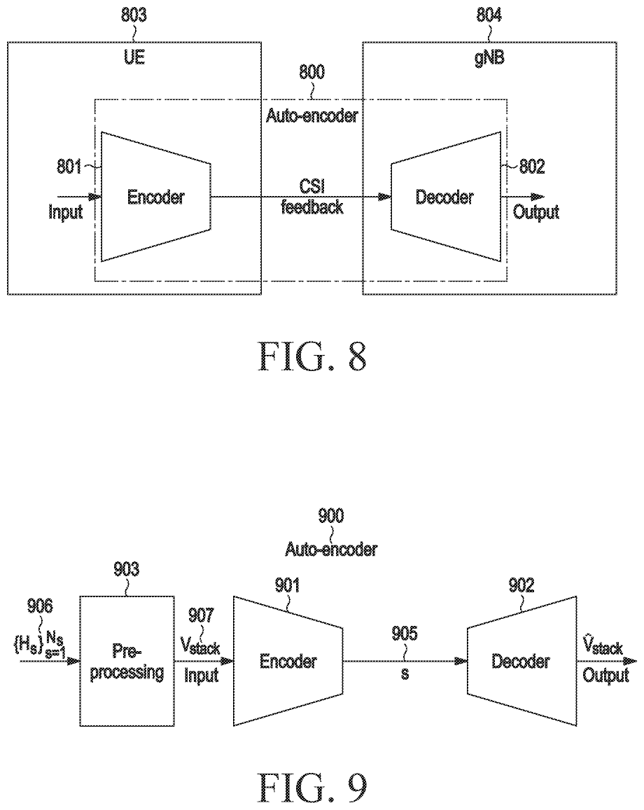

FIGS. 10A and 10B illustrate interference nulling operation for MU-MIMO by a gNB upon reception of CSI report with precoding matrices and full channel matrices, respectively according to various embodiments of the disclosure.

Referring to FIGS. 10A and 10B, as aforementioned, in 4G and 5G systems (FIG. 10A), UEs (1001), (1002), (1007), and (1008) report the precoding matrices via their indices as part of CSI report (1003), (1004), (1009), and (1010). And UEs including (1011) and (1012) receive interference nulling through data transmission (1005), (1006), (1013), and (1014). However, if the ‘full channel matrices’, i.e., the H matrices, are available at the gNB (FIG. 10B), various advantages can be reaped. One advantage is better interference nulling for multi-user MIMO (MU-MIMO) use case. Additionally, with the availability of full channel matrices at the gNB, the gNB can predict the future channel or precoder with higher accuracy as compared to the prediction with only the precoding matrices are available at the gNB.

In this disclosure, a multitude of full channel matrices reporting mechanisms are presented.

In the below various mechanisms for full channel matrices, i.e., full CSI, reporting are provided.

For the ease of the description of the disclosure, let H be an Nr×Nt channel matrix corresponding to a PMI reporting subband. Such channel matrix can be decomposed as H=UΣV^{H} where the svd(HH^{H})=U^{H}Σ²U and svd(H^{H}H)=VΣ²V^{H}. Then, the UE-side matrix, i.e., U=[u₁, u₂, . . . ] and the gNB-side matrix, i.e., V=[v₁, v₂, . . . ] can be used to reconstruct the full channel matrices. In particular, for transmission layer l, the scaled version of the channel matrix can be reconstructed as Hl=ulvₗ^{H} where H=Σₗλlulvₗ^{H} and λl is the l-^{th} eigenvalue.

In this disclosure, various ways of reporting full channel matrices are presented. In particular, instead of reporting the Nr×Nt channel matrices, for each layer of a reported rank (r), the UE-side and gNB-side vectors are reported. This is particularly beneficial for the most practical cases wherein a UE reports lower rank or gNB restricts the reporting to lower rank, i.e., r<Nr<Nt, as it significantly reduces reporting overhead. As an example, for 32 ports CSI-RS (gNB-side antenna ports) and 4 UE receive antenna ports, for rank 1, i.e., r=1, it is sufficient to report 32×1 and 4×1 vectors rather than 4×32 matrix per time-frequency unit.

A yet another application of the disclosure is CSI report for data collection for AI/ML model training and monitoring. When the AI/ML model training data is collected from multiple UEs, it is beneficial to collect the full channel matrices instead of gNB-side precoding vectors. This is to avoid the phase ambiguity that could result in different SVD algorithm implementation by the different UEs. Moreover, data collection based on full channel reporting assists development of AI/ML model for various use cases including channel (CSI) prediction, joint communication and sensing, or the like.

### Reporting Mechanism for a Single Time Instance CSI

As part of the current disclosure, in Method I, when the reported CSI is associated with a single measurement and/or a single time instance in the past or future (interpolated or predicted CSI), the UE can report a single UE-side and gNB-side vectors per each reporting subband and per each reported layer.

### I.1. UE-Side Vectors Reporting

In one aspect of this disclosure, in Method I.1.1, the UE reports the UE-side vectors by reporting a transmission precoding matrix indicator (TPMI) from the codebook configured for UL transmission.

In a yet another aspect of this disclosure, in Method I.1.2, the UE reports the UE-side vector, i.e., uₗ, by reporting a PMI associated with a two-stage codebook. This implies, UE reports the UE-side vector associated with layer l, uₗ, as W_{UE}=W_{UE,1}W_{UE,2}, where W_{UE,1} is a Nr×L_{UE}, spatial-domain (SD) basis vectors selection matrix and W_{UE,2} is L_{UE}×N₃ linear combination (LC) coefficients matrix for N₃ PMI reporting subbands. As a spatial case of Method I.1.2., when L_{UE}=1, the linear combination matrix W_{UE,2} reduces to a co-phasing coefficient. Then the Type I single panel codebook in [38.214] can be utilized.

Thus, as a consequence of the above aspect of this disclosure, when a UE is configured with codebook configuration corresponding to Method I.1.2, the UE reports PMI indicators i1, which indicates the SD basis matrix for the UE-side vectors, i.e., W_{UE,1}. Additionally, the UE reports indicators i2 which correspond to the LC matrix W_{UE,2}.

In a yet another aspect of this disclosure, in Method I.1.3, the UE reports the UE-side vector, i.e., uₗ, by applying frequency-domain compression. This implies, UE may report uₗ, as W_{UE}=W_{UE,1}W_{UE,2} (W_{UE,f})^{H} where W_{UE,1} is a Nr×L_{UE}, spatial-domain (SD) basis vectors selection matrix, W_{UE,f} is an N₃×Mᵥ, frequency-domain (SD) basis vectors selection matrix and W_{UE,2} is L_{UE}×M_{UE} linear combination (LC) coefficients matrix for reporting based on L_{UE} and M_{UE} SD and FD basis vectors.

Thus, as a consequence of the above aspect of this disclosure, when a UE is configured with codebook configuration corresponding to Method I.1.3, the UE reports PMI indicators i1, which indicate the SD basis matrices, i.e., W_{UE,1} and FD basis matrices W_{UE,f}, for the UE-side vectors. Additionally, the UE reports indicators i2 which correspond to the LC matrix W_{UE,2}.

In a yet another aspect of this disclosure, in Method I.1.4, the UE reports the UE-side vector, i.e., uₗ, by compressing it via AI/ML based CSI compression. In such a case, a UE reports an N-bits bit stream wherein the reported CSI is mapped back to N₃ UE-side vectors corresponding to N₃ subbands and each with dimensions Nᵣ×1.

Thus, as a consequence of the above aspect of this disclosure, when a UE is configured with codebook configuration corresponding to Method I.1.4, the UE reports AI/ML generated PMI indicators containing information for the UE-side vectors.

The list of configurations for Method I.1.1 to Method I.1.4. is given in Table 1.

TABLE 1
Single time instance CSI reporting configuration
for UE-side vector configuration.

| | | Method | Method | Method | Method |
|---|---|---|---|---|---|
| No. | Configuration from gNB | I.1.1 | I.1.2 | I.1.3 | I.1.4. |
| 1 | Number of SD basis vectors | NR | R | R | O |
| 2 | Number of FD basis vectors | NR | NR | R | O |
| 3 | Number of subbands | O | O | O | O |
| | (Channel Quality Indicator | | | | |
| | (CQI) subbands) | | | | |
| 4 | Number of PMI subbands | NR | NR | R | O |
| | per CQI subband | | | | |
| 5 | Quantization for | NR | R | R | O |
| | amplitude coefficients | | | | |
| 6 | Quantization for phase | NR | R | R | O |
| | coefficients | | | | |
| 7 | Explicit payload size | O | O | O | R |

NR = Not Required, O = Optional, R = Required.

I.2. gNB-Side Vectors Reporting

In a yet another aspect of this disclosure, in Method I.2.1, the UE reports the gNB-side vectors corresponding to layer l, i.e., {vₗ}, by reporting a PMI associated with a two-stage codebook. This implies, UE reports vₗ, as W_{gNB}=W_{gNB,1}W_{gNB,2}, where W_{gNB,1} is a Nt×L_{UE}, spatial-domain (SD) basis vectors selection matrix and W_{UE,2} is L_{gNB}×N₃ linear combination (LC) coefficients matrix for N₃ PMI reporting subbands. As a spatial case of Method I.2.1., when L_{UE}=1, the linear combination matrix W_{gNB,2} reduces to a co-phasing coefficient. Then the Type I single panel codebook in [38.214] can be utilized.

Thus, as a consequence of the above aspect of this disclosure, when a UE is configured with codebook configuration corresponding to Method I.2.1, the UE reports PMI indicators i₁, which indicates the SD basis matrix for the gNB-side vectors, i.e., W_{gNB,1}. Additionally, the UE reports indicators i₂ which correspond to the LC matrix W_{gNB,2}.

In a yet another aspect of this disclosure, in Method I.2.2, the UE reports the gNB-side vectors corresponding to layer l, i.e., {vₗ}, by applying frequency-domain compression. This implies, UE may report {vₗ}, as W_{gNB}=W_{gNB,1} W_{gNB,2} (W_{gNB,f})^{H} where W_{gNB,1} is a Nt×L_{gNB}, spatial-domain (SD) basis vectors selection matrix, W_{gNB,f} is an N₃×Mᵥ, frequency-domain (SD) basis vectors selection matrix and W_{gNB,2} is L_{gNB}×M_{gNB} linear combination (LC) coefficients matrix for reporting based on L_{gNB} and M_{gNB} SD and FD basis vectors.

Thus, as a consequence of the above aspect of this disclosure, when a UE is configured with codebook configuration corresponding to Method I.2.2, the UE reports PMI indicators i₁, which indicate the SD basis matrices, i.e., W_{gNB,1} and FD basis matrices W_{gNB,f}, for the UE-side vectors. Additionally, the UE reports indicators i₂ which correspond to the LC matrix W_{gNB,2}.

In a yet another aspect of this disclosure, in Method I.2.3, the UE reports the gNB-side vectors corresponding to layer l, i.e., {vₗ}, by compressing them via AI/ML based CSI compression. In such a case, a UE reports an N-bits bit stream wherein the reported CSI is mapped to N₃ UE-side vectors each with dimensions Nₜ×1.

Thus, as a consequence of the above aspect of this disclosure, when a UE is configured with codebook configuration corresponding to Method I.1.4, the UE reports AI/ML generated PMI indicators containing information for the gNB-side vectors.

TABLE 2
Single time instance CSI reporting configuration
for gNB-side vector configuration.

| | | Method | Method | Method |
|---|---|---|---|---|
| No. | Configuration from gNB | I.2.1 | I.2.2 | I.2.3. |
| 1 | Number of SD basis vectors | R | R | O |
| 2 | Number of FD basis vectors | NR | R | O |
| 3 | Number of subbands (CQI | O | O | O |
| | subbands) | | | |
| 4 | Number of PMI subbands | NR | R | O |
| | per CQI subband | | | |
| 5 | Quantization for amplitude | R | R | O |
| | coefficients | | | |
| 6 | Quantization for phase | R | R | O |
| | coefficients | | | |
| 7 | Explicit payload size | O | O | R |

NR = Not Required, O = Optional, R = Required.

I.3. Joint Reporting UE-Side and gNB-Side Vectors

In a yet another embodiment of this disclosure, the UE-side and gNB-side vectors can be fed back. It is to be noted that the UE side vectors can be feedback as a linear combination of SD basis vectors for each reporting subband, i.e.,

$${u}_{l} = {\sum }_{i}^{{L}_{UE}} \begin{matrix}{c}_{i , 0 , UE} {b}_{i , UE} \\ {c}_{i , 1 , UE} {b}_{i , UE}\end{matrix} and , {v}_{l} = {\sum }_{i}^{{L}_{gNB}} \begin{matrix}{c}_{i , 0 , gNB} {b}_{i , gNB} \\ {c}_{i , 1 , gNB} {b}_{i , gNB}\end{matrix}$$

where L_{UE} is the number of UE-side SD basis vectors L_{gNB} is the number of gNB-side SD basis vectors. c_{i,p,UE} and c_{i,p,gNB} the LC coefficient for the p-^{th} polarization and i-^{th} SD basis vector.

The matrix

$${u}_{l} {v}_{l}^{H} = {\sum }_{i}^{{L}_{UE}} {\sum }_{j}^{{L}_{gNB}} \begin{matrix}{c}_{i , 0} {{b}_{i , UE} ( {b}_{j , gNB} )}^{H} \\ {c}_{i , 1} {{b}_{i , UE} ( {b}_{j , gNB} )}^{H}\end{matrix} = {\sum }_{i}^{{L}_{UE}} {\sum }_{j}^{{L}_{gNB}} \begin{matrix}{c}_{i , j , 0} {A}_{i , j} \\ {c}_{i , j , 1} {A}_{i , j}\end{matrix}$$

can be expressed as a linear combination joint basis matrices A_{i,j}=b_{i,UE}(b_{j,gNB})^{H}.

In one aspect of this disclosure, in Method I.3.1 corresponding to the joint reporting of the UE-side and gNB-side vectors, the matrices {uₗvₗ^{H}} is reported as W=W₁ (W₂⊗I_{(Nt)}) where the joint SD basis matrix is given as W₁=[A_{0,1}A_{0,2} . . . , A_{L}_{_{UE}}_{×L}_{_{gNB}}] which is a Nr×NtL_{UE}L_{gNB} matrix. An indication for the joint basis matrices can be introduced. The UE can report such matrices L_{UE}×L_{gNB}. I_{(Nt)} is an identity matrix of size Nt. Moreover, ⊗ is a Kronecker product operator. Then, the linear combination matrix W₂ is a L_{gNB}L_{UE}×N₃ linear combination (LC) coefficients matrix.

Thus, as a consequence of the above aspect of this disclosure, when a UE is configured with codebook configuration corresponding to Method II.3.1, the UE reports PMI indicators i₁, which indicates the joint SD basis matrix for the UE-side and gNB-side vectors, i.e., W₁=[A_{0,1}A_{0,2} . . . , A_{L}_{_{UE}}_{×L}_{_{gNB}}]. Additionally, the UE reports an indicator i₂ which corresponds to the LC matrix W₂.

In a yet another aspect of this disclosure, in Method I.3.2 corresponding to the joint reporting of the UE-side and gNB-side vectors with frequency domain H where compression, the matrices {uₗvₗ^{H}} is reported as W=W₁(W₂⊗I_{(Nt)})(W_{f})^{H} where the joint SD basis matrix is given as W₁=[A_{0,1}A_{0,2} . . . , A_{L}_{_{UE}}_{×L}_{_{gNB}}] which is a Nr×NtL_{UE}L_{gNB} matrix. I_{(Nt)} is an identity matrix of size Nt. Moreover, ⊗ is a Kronecker product operator. Thereafter, the linear combination matrix W₂ is a L_{gNB}L_{UE}×Mᵥ linear combination (LC) coefficients matrix. Moreover, W_{f} is an N₃×Mᵥ, frequency-domain (SD) basis vectors matrix for Mᵥ selected and reported FD basis vectors.

Thus, as a consequence of the above aspect of this disclosure, when a UE is configured with codebook configuration corresponding to Method I.3.2, the UE reports PMI indicators i₁, which indicates the joint SD basis matrix for the UE-side and gNB-side vectors, i.e., W₁=[A_{0,1}A_{0,2} . . . , A_{L}_{_{UE}}_{×L}_{_{gNB}}] and FD basis matrices, W_{f}. Additionally, the UE reports an indicator i₂ which corresponds to the LC matrix W₂.

In a yet another aspect of this disclosure, in Method I.3.4, the UE reports the UE-side and gNB-side vectors corresponding to layer l, i.e., uₗvₗ^{H}}, by compressing them via AI/ML based CSI compression. In such a case, a UE reports an N-bits bit stream wherein the reported CSI is mapped to N₃ (reporting subbands) UE-side and gNB-side matrices each with dimensions Nr×Nₜ.

Thus, as a consequence of the above aspect of this disclosure, when a UE is configured with codebook configuration corresponding to Method I.3.4, the UE reports AI/ML generated PMI indicators containing information for the gNB-side vectors.

### Reporting Mechanism for Multiple Time Instances CSI (Time Correlated CSI Reporting)

In some cases, it is beneficial for the UE to report CSI associated to multiple time instances. The time instances could be in the past or future with respect to the time the CSI reported. If the CSI associated to multiple time instances are correlated, they can be compressed in the time-domain and reported. One use case for such reporting is to reduce the CSI reporting overhead.

And yet another use case is mitigation of channel aging. In particular, due to delay between CSI measurement, reporting and application time for reported CSI, i.e., physical downlink shared channel (PDSCH) scheduling, the reported CSI may get stalled. In such cases, it may be beneficial to report CSI associated to future time instances after applying CSI prediction from the UE side.

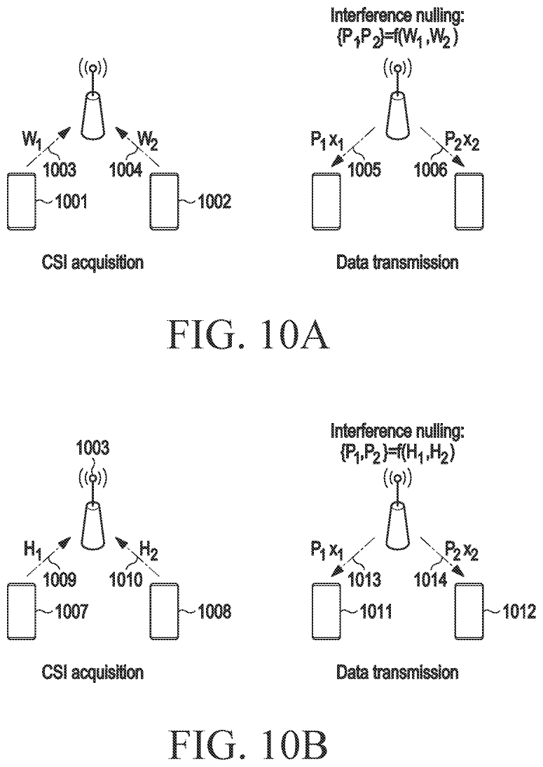

FIGS. 11A and 11B illustrate use cases for CSI report corresponding to multiple time instances periods according to an embodiment of the disclosure.

Referring to FIGS. 11A and 11B, in a yet another approach, the gNB may predict the CSI after receiving CSI associated to multiple time instances. One realization to achieve this is to allow the UE report CSI associated with multiple measurements as shown in FIG. 11A. In FIG. 11A, the UE reports a CSI (1101) associated with the time window in (1103). The CSI can therefore be associated with the multiple measurements within this window (1100).

In a yet another realization, depicted in FIG. 11B, the UE may predict CSI after multiple measurements (1104). Thereafter, the reported CSI (1105) will be associated to the time instances (1106) in the future of the measurement (1104).

Upon reporting time-correlated CSI associated with multiple time instances, the UE may apply time (Doppler)-domain compression on both UE-side and gNB-side vectors. For instance, suppose the channel matrices associated to N₄ time instances are denoted as H₁, H₂, . . . , H_{N4}, then the corresponding UE-side vectors and gNB-side vectors associated with layer I can be calculated as u_{l,1}, u_{l,2}, . . . , u_{l,N4} and v_{l,1}, V_{l,2}, . . . , v_{l,N4}.

### II.1. UE-Side Vectors Reporting

In one aspect of this disclosure, in Method II.1.1, the UE reports the UE-side vectors, i.e., {u_{l,1}, u_{l,2}, . . . , u_{l,N4}}, by applying frequency-domain and time-domain compression. One realization for this is that the UE may report u_{l,1}, u_{l,2}, . . . , u_{l,N4}, as W_{UE}=W_{UE,1} W_{UE,2} (W_{UE,f}⊗W_{UE,d})^{H} where W_{UE,1} is a Nr×L_{UE}, spatial-domain (SD) basis vectors matrix, W_{UE,f} is an N₃×Mᵥ, frequency-domain (SD) basis vectors selection matrix, W_{UE,d} is an N₄×Q, Doppler-domain (DD) basis vectors selection matrix, and W_{UE,2} is L_{UE}×M_{UE}Q linear combination (LC) coefficients matrix for reporting based on L_{UE} and M_{UE} SD and FD basis vectors. Moreover, ⊗ is a Kronecker product.

Thus, as a consequence of the above aspect of this disclosure, when a UE is configured with codebook configuration corresponding to Method II.1.1, the UE reports PMI indicators i₁, which indicate the SD basis matrices, i.e., W_{UE,1} and FD and DD basis matrices W_{UE,f} W_{UE,d}, for the UE-side vectors. Additionally, the UE reports indicators i₂ which correspond to the LC matrix W_{UE,2}.

In a yet another aspect of this disclosure, in Method II.1.2, the UE reports the UE-side vectors, i.e., {u_{l,1}, u_{l,2}, . . . , u_{l,N4}}, by compressing them via AI/ML based CSI compression. In such a case, a UE reports an N-bits bit stream wherein the reported CSI is mapped back to N₄×N₃ UE-side vectors corresponding to N₄ time instances and N₃ subbands and each vector having dimension of Nᵣ×1.

Thus, as a consequence of the above aspect of this disclosure, when a UE is configured with codebook configuration corresponding to Method II.1.2, the UE reports AI/ML generated PMI indicators containing information for the UE-side vectors corresponding to N₃ subbands and N₄ subtimes in the frequency and time domains, respectively.

TABLE 3
Multiple time instances CSI reporting configuration
for UE-side vector configuration.

| | | Method | Method |
|---|---|---|---|
| No. | Configuration from gNB | II.1.1 | II.1.2 |
| 1 | Number of SD basis vectors | R | O |
| 2 | Number of FD basis vectors | R | O |
| 3 | Number of DD basis vectors | R | O |
| 4 | Number of subbands (CQI subbands) | R | O |
| 5 | Number of PMI subbands per CQI subband | O | NR |
| 6 | Quantization for amplitude coefficients | R | O |
| 7 | Quantization for phase coefficients | R | O |
| 8 | Explicit payload size | O | R |

NR = Not Required, O = Optional, R = Required.

II.2. gNB-Side Vectors Reporting

In one aspect of this disclosure, in Method II.2.1, the UE reports the gNB-side vectors, i.e., {v_{l,1}, v_{l,2}, . . . , v_{l,N4}}, by applying frequency-domain and time-domain compression. One realization for this is that UE reports v_{l,1}, v_{l,2}, . . . , v_{l,N4}, as W_{gNB}=W_{gNB,1} W_{gNB,2} (W_{gNB,f} & W_{gNB,d})^{H} where W_{gNB,1} is a Nr×L_{gNB}, spatial-domain (SD) basis vectors selection matrix, W_{gNB,f} is an N₃×Mᵥ, frequency-domain (FD) basis vectors matrix, W_{UE,d} is an N₄×Q Doppler-domain (DD) basis vectors matrix, and W_{UE,2} is L_{gNB}×M_{gNB}Q linear combination (LC) coefficients matrix for reporting based on L_{UE}, M_{UE}, and Q basis vectors for SD, FD and DD, respectively. Moreover, ⊗ is a Kronecker product.

Thus, as a consequence of the above aspect of this disclosure, when a UE is configured with codebook configuration corresponding to Method II.2.1, the UE reports PMI indicators i₁, which indicate the SD basis matrices, i.e., W_{gNB,1} and FD and DD basis matrices W_{gNB,f} W_{gNB,d}, for the gNB-side vectors. Additionally, the UE reports indicators i₂ which correspond to the LC matrix W_{gNB,2}.

In a yet another aspect of this disclosure, in Method II.2.2, the UE reports the UE-side vectors, i.e., {v_{l,1}, v_{l,2}, . . . , v_{l,N4}}, by compressing them via AI/ML based CSI compression. In such a case, a UE reports an N-bits bit stream wherein the reported CSI is mapped back to N₄×N₃ UE-side vectors corresponding to N₄ time instances and N₃ subbands and each with dimension of Nₜ×1.

Thus, as a consequence of the above aspect of this disclosure, when a UE is configured with codebook configuration corresponding to Method II.2.2, the UE reports AI/ML generated PMI indicators containing information for the gNB-side vectors corresponding to N₃ subbands and N₄ subtimes in the frequency and time domains, respectively.

TABLE 4
Multiple time instances CSI reporting configuration
for gNB-side vector configuration.

| | | Method | Method |
|---|---|---|---|
| No. | Configuration from gNB | II.2.1 | II.2.2 |
| 1 | Number of SD basis vectors | R | O |
| 2 | Number of FD basis vectors | R | O |
| 3 | Number of DD basis vectors | R | O |
| 4 | Number of subbands (CQI subbands) | R | O |
| 5 | Number of PMI subbands per CQI subband | O | NR |
| 6 | Quantization for amplitude coefficients | R | O |
| 7 | Quantization for phase coefficients | R | O |
| 8 | Explicit payload size | O | R |

NR = Not Required, O = Optional, R = Required.

II.3. Joint Reporting UE-Side and gNB-Side Vectors

In a yet another embodiment of this disclosure, the UE-side and gNB-side vectors can be fed back jointly. It is to be noted that the UE side vectors can be fedback as a linear combination of SD basis vectors for each reporting subband, i.e.,

$${u}_{l} = {\sum }_{i}^{{L}_{UE}} \begin{matrix}{c}_{i , 0 , UE} {b}_{i , UE} \\ {c}_{i , 1 , UE} {b}_{i , UE}\end{matrix} and , {v}_{l} = {\sum }_{i}^{{L}_{gNB}} \begin{matrix}{c}_{i , 0 , gNB} {b}_{i , gNB} \\ {c}_{i , 1 , gNB} {b}_{i , gNB}\end{matrix}$$

where L_{UE} is the number of UE-side SD basis vectors L_{gNB} is the number of gNB-side SD basis vectors. c_{i,p,UE} and c_{i,p,gNB} the LC coefficient for the p-^{th} polarization and i-^{th} SD basis vector.

The channel matrix for layer l, i.e., uₗvₗ^{H}, can be expressed as

$${u}_{l} {v}_{l}^{H} = {\sum }_{i}^{{L}_{UE}} {\sum }_{j}^{{L}_{gNB}} \begin{matrix}{c}_{i , 0} {{b}_{i , UE} ( {b}_{j , gNB} )}^{H} \\ {c}_{i , 1} {{b}_{i , UE} ( {b}_{j , gNB} )}^{H}\end{matrix} = {\sum }_{i}^{{L}_{UE}} {\sum }_{j}^{{L}_{gNB}} \begin{matrix}{c}_{i , j , 0} {A}_{i , j} \\ {c}_{i , j , 1} {A}_{i , j}\end{matrix}$$

as a linear combination joint basis matrices A_{i,j}=b_{i,UE}(b_{j,gNB})^{H} where c_{i,j,p}=c_{i,j,p}=c_{i,p,UE}c_{j,p,gNB}.

In a yet another aspect of this disclosure, in Method II.3.1, the UE jointly report the UE-side and gNB-side vectors with frequency domain (FD) and time-domain (TD) compression, the matrices {uₗvₗ^{H}} is reported as W=W₁ (W₂⊗I_{(Nt)}) (W_{f}⊗W_{d})^{H} where the joint SD basis matrix is given as W₁=[A_{0,1}A_{0,2} . . . , A_{L}_{_{UE}}_{×L}_{_{gNB}}] which is a Nr×NtL_{UE}L_{gNB} matrix. I_{(Nt)} is an identity matrix of size Nt. Moreover, ⊗ is a Kronecker product operator. Thereafter, the linear combination matrix W₂ is a L_{gNB}L_{UE}×Mᵥ linear combination (LC) coefficients matrix. Moreover, W_{f} is an N₃×Mᵥ, frequency-domain (FD) basis vectors matrix for Mᵥ selected and reported FD basis vectors. Additionally, W_{d} is an N₄×Q, Doppler-domain (DD) basis vectors matrix.

Thus, as a consequence of the above aspect of this disclosure, when a UE is configured with codebook configuration corresponding to Method II.3.1, the UE reports PMI indicators i₁, which indicates the joint SD basis matrix for the UE-side and gNB-side vectors, i.e., W₁=[A_{0,1}A_{0,2} . . . , A_{L}_{_{UE}}_{×L}_{_{gNB}}], in addition to FD and DD basis matrices W_{f} and W_{d}, respectively. Additionally, an indicator i₂ which corresponds to the LC matrix W₂.

### Configuration Aspects and Capability Signaling

### III.1. CSI Reporting Configuration and Reconstruction

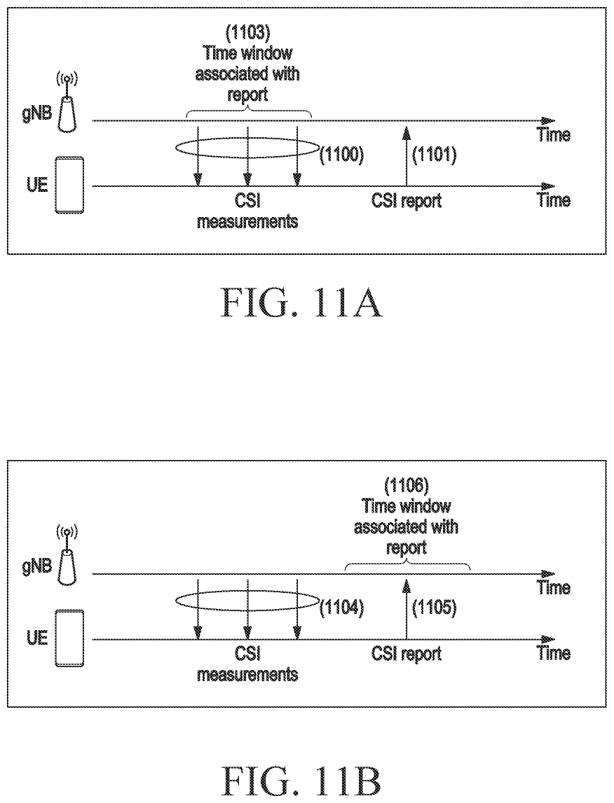

In one aspect of this disclosure, as depicted in FIG. 12A, the gNB may configure the UE with a single CSI report configuration. The CSI report configuration may be linked with one codebook configuration corresponding to UE-side and gNB-side vectors reporting.

FIGS. 12A, 12B, and 12C, illustrate CSI report configuration approaches according to an embodiment of the disclosure.

Referring to FIGS. 12A, 12B, and 12C, as depicted in FIG. 12B, the gNB may configure the UE (in operation 1200) with a single CSI report configuration. The CSI report configuration may be linked to two codebook configurations—one for UE-side (1203 and 1208) and one for the gNB-side vectors reporting (1204 and 1209), respectively.

In a yet another aspect of this disclosure, as depicted in FIGS. 12B and 12C, the gNB may configure the UE with two CSI report configurations (in operations 1202, 1205, and 1207). The two CSI report configurations may consist of codebook configuration (1206) for UE-side and gNB-side vectors reporting, respectively. Upon reception of a CSI report request, e.g., via DCI, corresponding to the two CSI report configurations, the UE reports the UE-side and gNB-side vectors accordingly.

Moreover, for single time instance CSI reporting, as shown below, the gNB may configure one of the methods for UE-side vectors reporting, i.e., Method I.1.1. to Method I.1.4 and gNB-side vectors reporting, i.e., Method I.2.1. to Method I.2.3.

Similarly, for multiple time instances CSI reporting, as shown below, the gNB may configure one of the methods for UE-side vectors reporting, i.e., Method II.1.1. to Method II.1.2 and gNB-side vectors reporting, i.e., Method II.2.1. to Method II.2.1.

### III.2. Time-Domain Property for CSI Reporting

The time-domain property of a CSI report can be configured to be PERIODIC, SEMI-PERSISTENT and APERIODIC. When the gNB configures the UE to report CSI corresponding to full channel reporting with two CSI report configurations, i.e., for UE-side and gNB-side vectors reporting, some restriction can be introduced for the time-domain behavior of the CSI reporting.

In one aspect of the disclosure, the two linked CSI report configurations corresponding to the UE-side and gNB-side vectors reporting, are expected to be configured with the same time-domain property. Therefore, the UE does not expect to be configured with linked CSI report configurations for full channel reporting with different time-domain property configuration.

In most cases, the CSI report for full channel reporting is for the gNB to obtain the suitable downlink precoding vector. In this use case, therefore, the gNB-side vectors hold higher priority as compared to the UE-side vectors reporting. Thus, it may not be preferred to report the CSI for UE-side vectors without companying the by gNB-side vectors. However, in some cases, similar to legacy CSI reporting, it may still be useful if the UE reports the CSI corresponding to gNB-side vectors without the associated UE-side vectors. In a yet another aspect of the disclosure, the two linked CSI report configurations corresponding to the UE-side and gNB-side vectors can be configured with different time-domain properties with the following restriction.

For two linked CSI report configurations for full channel reporting, the UE may be configured with PERIODIC CSI reporting for gNB-side vectors reporting and PERIODIC or SEMI-PERSISTENT or APERIODIC CSI report configurations for UE-side vector reporting.

For two linked CSI report configurations for full channel reporting, the UE may be configured with SEMI-PERSISTENT CSI reporting for gNB-side vectors reporting, and SEMI-PERSISTENT or APERIODIC CSI report configurations for UE-side vector reporting. Thus, for two linked CSI report configurations for full channel reporting, the UE does not expect to be configured with PERIODIC CSI report configurations for UE-side vector reporting and SEMI-PERSISTENT CSI reporting for gNB-side vectors reporting.

For two linked CSI report configurations for full channel reporting, the UE may be configured with APERIODIC CSI reporting for gNB-side vectors reporting APERIODIC CSI report configurations for UE-side vector reporting. Thus, for two linked CSI report configurations for full channel reporting, the UE does not expect to be configured with PERIODIC or SEMI-PERSISTENT CSI report configurations for UE-side vector reporting and APERIODIC CSI reporting for gNB-side vectors reporting.

### III.3. Two Parts CSI Report and Dropping Rules

In some scenarios the configured uplink resources, e.g., physical uplink control channel (PUCCH) or physical uplink shared channel (PUSCH), to carry the CSI report may not be sufficient. This is especially possible when the reported CSI has to be multiplexed with other types of uplink transmission, e.g., uplink data, scheduling request, hybrid automatic repeat request (HARQ). In this scenario, instead of dropping the whole CSI report, it may be beneficial to drop part of it and transmit the CSI with a lower resolution. The 5G NR specification allows the CSI report to be partitioned in to two parts wherein Part I consists of the most essential components of the CSI report and Part II consists of the rest of the components. Moreover, Part I is set to be of fixed size and its content indicates to the gNB the size of Part II. Additionally, priority rules are defined in order to prioritize the components of CSI to be dropped and retained.

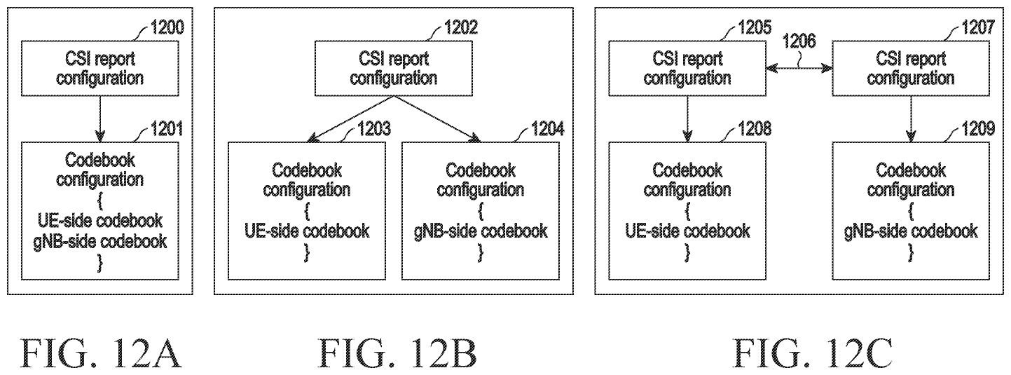

FIGS. 13A and 13B illustrate an embodiment for two parts CSI reporting for CSI reporting corresponding to full channel matrices reporting according to an embodiment of the disclosure.

This disclosure introduces two different ways of grouping CSI components for full channel matrix reporting. Referring to FIGS. 13A and 13B, the CSI report can be partitioned in to two parts, i.e., Part 1 (1300) and (1305) and Part 2 (1301) and (1306).

As one embodiment of this disclosure, illustrated in FIG. 13A, Part II CSI is divided in to three groups. Then the CSI components corresponding to UE-side and gNB-side vectors reporting can be mapped in to these three groups, Group 0 (1302), Group 1 (1303) and Group 2 (1304), with a decreasing order of priority (most important to less important).

As an example, for the scheme illustrated in FIG. 13A, when Method I.1.3 and Method I.2.2 are configured for UE-side and gNB-side vectors reporting, the following mapping can be followed. Part 1 may consist of rank indicator (RI) (if reported), CQI, and the overall number of non-zero amplitude coefficients across layers for the UE-side and gNB-side vectors reporting. Whereas, Part 2 may contain the PMI for UE-side and gNB-side vectors reporting. Moreover, Group 0 may contain PMI components indicating the SD basis vectors and strongest coefficient indicator for each layer of the UE-side and gNB side vectors. While Group 1 includes indices indicating the initialization for FD basis selection window, the FD basis selection indicator, a bit map for the nonzero components, the per-polarization and the highest priority per SD-FD basis pair amplitude coefficients and the highest priority per-SD-FD basis vectors pairs phase components for UE-side and/or gNB-side vectors. Then, Group 2 contains the reported PMI components that are not included in

In a yet another embodiment of this disclosure, as illustrated in FIG. 13B, Part 2 CSI is divided in to three groups for each of gNB-side (1307, 1308, and 1309) and UE-side (1310, 1311, 1312) vectors reporting. Thus, transmission of gNB-side vectors takes higher priority (importance) as compared to UE-side vector.

### III.4. Time and Frequency Units Configuration

Another configuration aspect is the reporting granularity in the time and frequency domains. The UE-side vectors and gNB-side vectors reporting can share the same reporting granularity configurations. However, as the UE-side vectors are less frequency and time selective as compared to the gNB-side vectors, it may be beneficial to configure the reporting granularity separately.

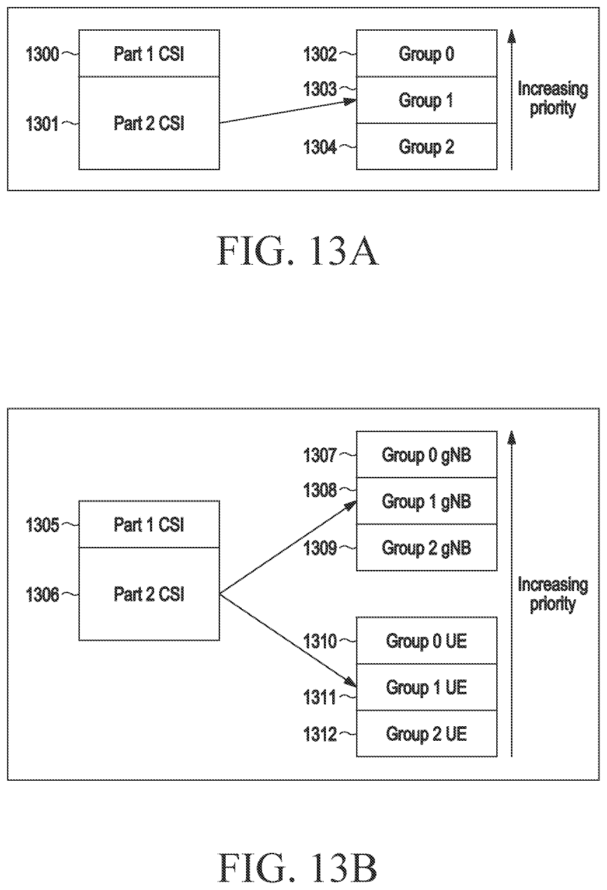

FIG. 14 illustrates a configuration for time-frequency granularity of UE-side and gNB side channel components reporting according to an embodiment of the disclosure.

Referring to FIG. 14, the gNB can configure the UE with separate reporting granularity configuration for UE-side and gNB-side vectors. As an example, in frequency domain, the gNB can configure the UE report (1400 and 1402) PMI in 4 and 8 RBs (1401 and 1403) for gNB and UE-side vectors reporting, respectively. Similarly, in the time domain the gNB can configure the UE report PMI in 1 and 2 slots for gNB and UE-side vectors reporting, respectively.

The reporting granularity for UE-side vectors reporting can also be derived from the reporting granularity of the gNB-side vectors reporting. As an example, a UE can be configured with the reporting granularity for gNB-side vectors and derive the reporting granuality for UE-side vectors reporting directly based on a predetermined rule.

### III.5. UE Capability Reporting, Reporting Timeline and CPU Occupation

The reporting of full channel matrix (CSI) requires additional processing capability as compared to reporting just the gNB-side vectors. Thus, a UE capable of reporting the full channel matrix can indicate to gNB its capability so that the gNB would configure it with appropriate CSI reporting configuration.

In one aspect of this disclosure, the UE may indicate to the gNB via capability signaling that it is capable of reporting full-channel matrices. This indication may contain one or multitude of tuples of the maximum number of resources across all CCs, maximum number of Tx ports per resources and the total number of Tx ports across all CCs within a band combination. Moreover, an additional capability indication can also be provided by the UE on its supported maximum number of UE-side antenna ports. A tuple of supported number of TX-RX antenna ports can also be indicated by the UE. As an example, The UE may indicate (4,8) and (2,16) for (max number of UE-side antenna ports, max number of gNB-side antenna ports).

Another consideration is CSI processing unit (CPU) occupancy for full channel reporting. As compared to the legacy reporting for gNB-side vectors reporting, full channel matrix reporting requires additional computational resources. Thus, the UE and gNB would assume that the number of CPUs occupied for full channel reporting is x>1 times of that of the CPU required for legacy CSI reporting, i.e., reporting the gNB-side vectors only. A value for x report could be 1.5 or 2. In some cases, there could be different classes of UE's with different level of efficiency and complexity for computing the CSI for full-channel matrices. In this case, it may be useful if the UE reports the CPU occupancy for full channel CSI reporting from candidate values as capability report. In case the UE can compute the CSI with lower computational complexity, the UE may indicate to the gNB lower values for the associated CPU occupancy.

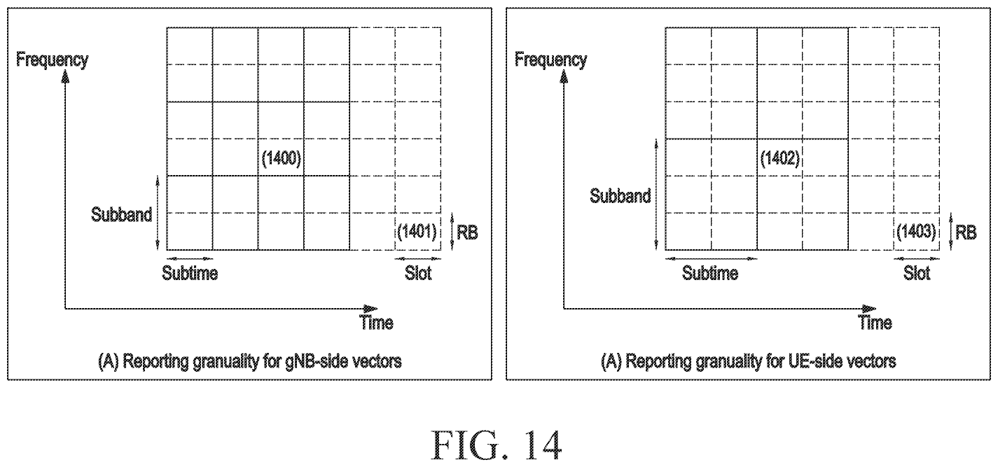

FIG. 15 illustrates an example of an operation of a UE according to an embodiment of the disclosure; and

Referring to FIG. 15, in step 1510, the UE may receive, from a base station, configuration information for a channel state information (CSI) report.

In step 1520, the UE may identify a precoding matrix indicator (PMI) of at least one code book based on the configuration information.

In step 1530, the UE may transmit, to the base station, the CSI report including the PMI. In an embodiment, the PMI indicates information related to UE-side vectors and base station-side vectors. In an embodiment, the PMI indicates information related to UE-side vectors and base station-side vectors.

In an embodiment, the UE may receive, from the base station, a physical downlink shared channel (PDSCH) based on the PMI. In an embodiment, the PMI indicates a joint spatial domain (SD) basis matrix for the UE-side vectors and the base station-side vectors. In an embodiment, the configuration information includes first configuration information related to the UE-side vectors and second configuration information related to the base station-side vectors. In an embodiment, the first configuration information has a higher priority than the second configuration information.

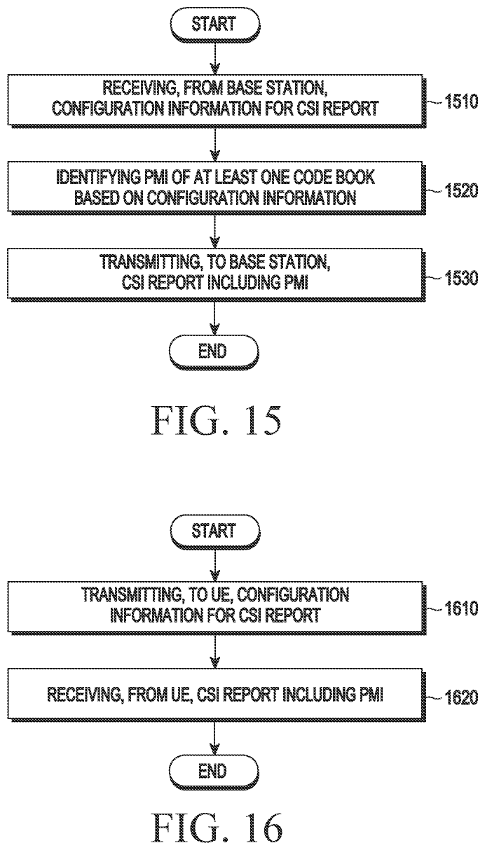

FIG. 16 illustrates an example of an operation of a base station according to an embodiment of the disclosure.

Referring to FIG. 16, in step 1610, the base station may transmit, to a user equipment (UE), configuration information for a channel state information (CSI) report. In step 1620, the base station may receive, from the UE, the CSI report including a precoding matrix indicator (PMI). In an embodiment, the base station may transmit, to the UE, a physical downlink shared channel (PDSCH) based on the PMI. In an embodiment, the at least one code book is related to UE-side codebook and base station-side codebook. In an embodiment, the PMI indicates a joint spatial domain (SD) basis matrix for the UE-side vectors and the base station-side vectors. In an embodiment, the configuration information includes first configuration information related to the UE-side vectors and second configuration information related to the base station-side vectors. In an embodiment, the first configuration information has a higher priority than the second configuration information.

Accordingly, an aspect of the disclosure is to provide a method and apparatus for codebook based channel state information (CSI) reporting for full channel matrices in communication networks, wherein the communication network is at least one of the 5^{th} generation (5G) standalone network, a 5G non-standalone (NAS) network or 6^{th} generation (6G) network.

Another aspect of the disclosure is to provide methods and systems to configure a user equipment (UE) with a CSI report for full channel reporting derived for a single time instance or time period.

Another aspect of the disclosure is to provide methods and systems to configure a UE with a CSI report for full channel reporting derived for multiple time instances or time periods.

Another aspect of the disclosure is to provide methods and systems for a UE upon receiving CSI report configuration from the gNodeB (gNB) to report a CSI with a CSI report for full channel matrices reporting wherein the CSI is derived for single time instance or time period.

Another aspect of the disclosure is to provide methods and systems for a UE upon receiving CSI report configuration from the gNB to report a CSI with a CSI report for full channel matrices reporting wherein the CSI is derived for multiple time instances or time periods.

Additional aspects will be set forth in part in the description which follows and, in part, will be apparent from the description, or may be learned by practice of the presented embodiments.

In accordance with an aspect of the disclosure, a method performed by a base station in a wireless communication system is provided. The method includes transmitting, to a terminal, configuration information about CSI reporting for full channel matrices.

In accordance with another aspect of the disclosure, a method performed by a user terminal in a wireless communication system is provided. The method includes receiving, from a base station, configuration information about CSI reporting for full channel matrices.

In accordance with another aspect of the disclosure, a method performed by a base station in a wireless communication system is provided. The method includes transmitting, to a terminal, configuration information about UE-side eigenvectors of channel covariance matrices as part of a CSI report.

In accordance with another aspect of the disclosure, a method performed by a user terminal in a wireless communication system is provided. The method includes receiving, from a base station, configuration information about UE-side eigenvectors of channel covariance matrices as part of a CSI report.

In accordance with another aspect of the disclosure, a method performed by a base station in a wireless communication system is provided. The method includes transmitting, to a terminal, configuration information about gNB-side eigenvectors of channel covariance matrices as part of a CSI report.

In accordance with another aspect of the disclosure, a method performed by a user terminal in a wireless communication system is provided. The method includes receiving, from a base station, configuration information about gNB-side eigenvectors of channel covariance matrices as part of a CSI report.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

Thereafter, if a CSI-ReportConfig is configured with a codebookType set to a codebook associated with one of the aforementioned methods for full channel reporting, and the corresponding CSI-RS resource set measurement is configured with Ks number of CSI-RS resources in a resource set for channel measurement, then O_{CPU}=xKₛ CPUs are occupied for the processing of a CSI report.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a wireless communication system, the method comprising:
receiving, from a base station, configuration information for a channel state information (CSI) report;
identifying a precoding matrix indicator (PMI) of at least one code book based on the configuration information; and
transmitting, to the base station, the CSI report including the PMI,
wherein the PMI indicates information related to UE-side vectors and base station-side vectors.

2. The method of claim 1, further comprising:
receiving, from the base station, a physical downlink shared channel (PDSCH) based on the PMI.

3. The method of claim 1,
wherein the at least one code book is related to UE-side codebook and base station-side codebook.

4. The method of claim 1,
wherein the PMI indicates a joint spatial domain (SD) basis matrix for the UE-side vectors and the base station-side vectors.

5. The method of claim 1,
wherein the configuration information includes first configuration information related to the UE-side vectors and second configuration information related to the base station-side vectors, and
wherein the first configuration information has a higher priority than the second configuration information.

6. A method performed by a base station in a wireless communication system, the method comprising:
transmitting, to a user equipment (UE), configuration information for a channel state information (CSI) report; and
receiving, from the UE, the CSI report including a precoding matrix indicator (PMI),
wherein the PMI of at least one code book is identified based on the configuration information, and
wherein the PMI indicates information related to UE-side vectors and base station-side vectors.

7. The method of claim 6, further comprising:
transmitting, to the UE, a physical downlink shared channel (PDSCH) based on the PMI.

8. The method of claim 6,
wherein the at least one code book is related to UE-side codebook and base station-side codebook.

9. The method of claim 6,
wherein the PMI indicates a joint spatial domain (SD) basis matrix for the UE-side vectors and the base station-side vectors.

10. The method of claim 6,
wherein the configuration information includes first configuration information related to the UE-side vectors and second configuration information related to the base station-side vectors, and
wherein the first configuration information has a higher priority than the second configuration information.

11. A user equipment (UE) in a wireless communication system, the UE comprising:
a transceiver; and
at least one processor couple to the transceiver and configured to:
receive, from a base station, configuration information for a channel state information (CSI) report,
identify a precoding matrix indicator (PMI) of at least one code book based on the configuration information, and
transmit, to the base station, the CSI report including the PMI,
wherein the PMI indicates information related to UE-side vectors and base station-side vectors.

12. The UE of claim 11, wherein at least one processor is further configured to:
receive, from the base station, a physical downlink shared channel (PDSCH) based on the PMI.

13. The UE of claim 11,
wherein the at least one code book is related to UE-side codebook and base station-side codebook.

14. The UE of claim 11,
wherein the PMI indicates a joint spatial domain (SD) basis matrix for the UE-side vectors and the base station-side vectors.

15. The UE of claim 11,
wherein the configuration information includes first configuration information related to the UE-side vectors and second configuration information related to the base station-side vectors, and
wherein the first configuration information has a higher priority than the second configuration information.

16. A base station in a wireless communication system, the base station comprising:
a transceiver; and
at least one processor couple to the transceiver and configured to:
transmit, to a user equipment (UE), configuration information for a channel state information (CSI) report, and
receive, from the UE, the CSI report including a precoding matrix indicator (PMI),
wherein the PMI of at least one code book is identified based on the configuration information, and
wherein the PMI indicates information related to UE-side vectors and base station-side vectors.

17. The base station of claim 16, wherein the at least one processor is further configured to:
transmit, to the UE, a physical downlink shared channel (PDSCH) based on the PMI.

18. The base station of claim 16,
wherein the at least one code book is related to UE-side codebook and base station-side codebook.

19. The base station of claim 16,
wherein the PMI indicates a joint spatial domain (SD) basis matrix for the UE-side vectors and the base station-side vectors.

20. The base station of claim 16,
wherein the configuration information includes first configuration information related to the UE-side vectors and second configuration information related to the base station-side vectors, and
wherein the first configuration information has a higher priority than the second configuration information.
